(19) United States
(12) Patent Application Publication
(10) Pub. No.: US 2008/0208717 A1
(43) Pub. Date: Aug. 28, 2008

(54) Internet auction system and method

(76) Inventor: Tim Suleymanov, San Francisco, CA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 12/070,379

(22) Filed: Feb. 15, 2008

Related U.S. Application Data
(60) Provisional application No. 60/890,095, filed on Feb. 15, 2007.

(51) Int. Cl. G06Q 30/00

(52) U.S. Cl. 705/27

(57) ABSTRACT

The inventive system includes a software that allows a buyer to monitor and control competing interaction between various sellers by simultaneously accessing the desired item's description, image, if available or if requested, and other information, and coordinating communication between these sellers to make a final choice. A computer based auction system, wherein any potential seller, placing an item on auction, may monitor a negotiating process between potential bidders during a negotiation phase and based on development of the negotiation between the bidders and the seller's need to sell the item due to various circumstances, the seller may decrease the price of the negotiated item and/or move the item to the auction phase before the designated time, thereby selling the item.

### RELATED APPLICATION

This application claims priority to U.S. Provisional Patent Application Ser. No. 60/890,095 filed Feb. 15, 2007.

### FIELD OF INVENTION

This invention subject relates to method and systems for conduction business via Internet. More particularly, this invention subject relates to an auction system and method for auctioning of products on-line where various participants use computer terminals to access a computer site to participate in the auction.

### BACKGROUND OF THE INVENTION

The art is replete with numerous Internet auction system and method related to auctioning of products on-line wherein various participants use computer terminals to access a computer site to participate in the auction. However, there is ongoing demand to improve these prior art auction systems and methods to

### SUMMARY OF THE INVENTION

The system of the present invention includes at least one web server computer designed for serving a host of computer browsers and providing the browsers with the capability to participate in various auctions at a specified time, with a specified number of items available for sale. The web server cooperates with a separate database computer, which is accessible to the web server computer to allow selective retrieval of the items information, such as, for example, description and quantity of the item to be auctioned; a starting price of the item; at least one image of the item, if available, and the like.

A custom designed application software of the inventive Internet auction system and method is integrated in the web server computer and is written to perform various functions. One of the functions, for example, is designed for auctioning any item identified in the database computer by displaying, during a negotiation phase and an auction phase of the present invention, the current price of the item, the quantity of the item remaining available for purchase and the measure of the time remaining in the negotiation and auction phases. The application software provides for indicating instructions to purchase the item at a displayed current price, continually updating the current price of the item, the quantity of the items remaining available for purchase, showing the product indicated as purchased. The application software is also written in a way to indicate the time remaining in the auction in order to provide dynamic feedback to each user and removing the user from the auction after obtaining identification and required financial authorization for the purchase of the item.

Referring back to the negotiation and auction phases of the inventive Internet auction system and method, each seller sets up a designated time when the auction phase will begin. The starting price of the item to be auctioned is also designated. The negotiation phase is established before the beginning of the auction phase to provide potential buyers, i.e. bidders with a chance to compete. For example, the seller places a book for 300 dollars and sets up a designated time and duration of the auction phase. In addition, the seller sets up the time when the negotiation phase will begin. When the negotiation phase begins and in the process of the negotiation phase, the seller monitors the negotiating process between the bidders and based on development of the negotiation process between the bidders and the seller's need to sell the item due to various circumstances, the seller may decrease the price of the negotiated item and/or move the item to the auction phase before the designated time, thereby selling the item as quick as possible encouraging the bidders to compete between one another.

Another function, for example, is designed for coordinating an electronic communication between a potential buyer and a plurality of potential sellers via the inventive Internet auction system and method with the sellers competing one with the other and simultaneously communicating with the potential buyer via the Internet. The aforementioned software is designed to display, i.e. post a desired item in a web site, and simultaneously receive data, such as the desired item's description, image, if available or if requested, and other information, from the potential sellers. The software allows the buyer to monitor and control competing interaction between various sellers and to coordinates communication between these sellers to make a final choice.

In summary, the inventive system includes a software that allows a buyer to monitor and control competing interaction between various sellers by simultaneously accessing the desired item's description, image, if available or if requested, and other information, and coordinating communication between these sellers to make a final choice. A computer based auction system, wherein any potential seller, placing an item on auction, may monitor a negotiating process between potential bidders during a negotiation phase and based on development of the negotiation between the bidders and the seller's need to sell the item due to various circumstances, the seller may decrease the price of the negotiated item and/or move the item to the auction phase before the designated time, thereby selling the item.

### DETAILED DESCRIPTION OF THE DRAWINGS

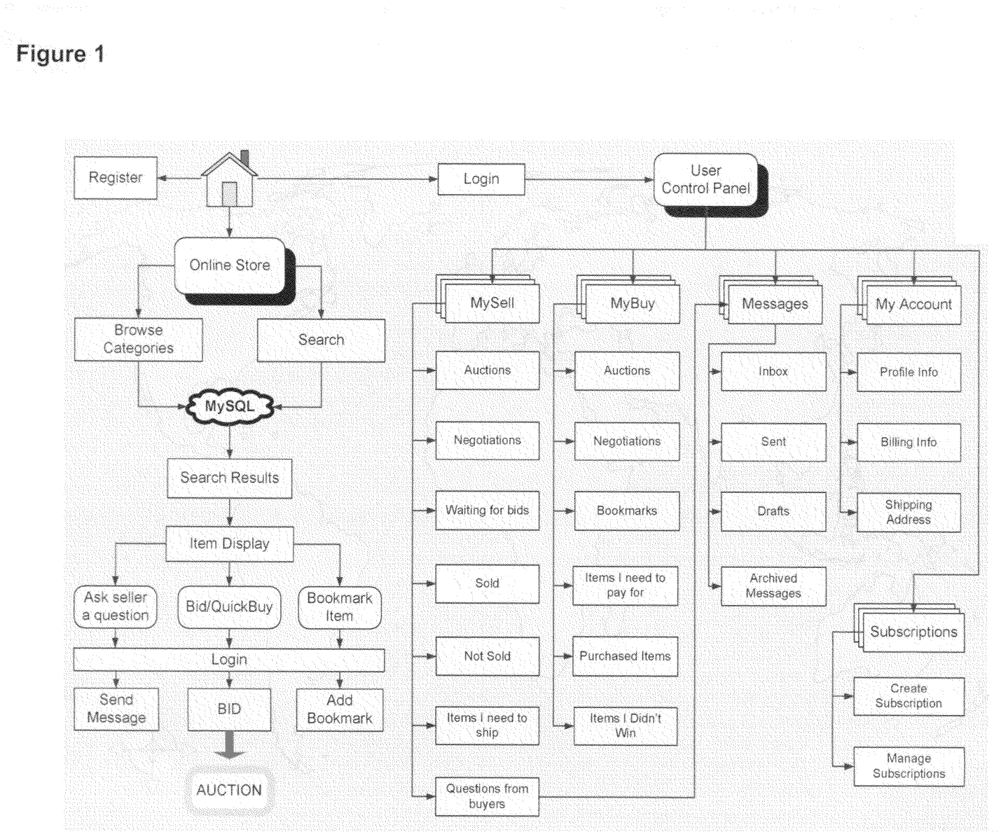

FIG. 1 shows a schematic view of the present invention.

### DETAILED DESCRIPTION OF THE INVENTION

The system of the present invention includes at least one web server computer designed for serving a host of computer browsers and providing the browsers with the capability to participate in various auctions at a specified time, with a specified number of items available for sale. The web server cooperates with a separate database computer, which is accessible to the web server computer to allow selective retrieval of the items information, such as, for example, description and quantity of the item to be auctioned; a starting price of the item; at least one image of the item, if available, and the like.

A custom designed application software of the inventive Internet auction system and method is integrated in the web server computer and is written to perform various functions. One of the functions, for example, is designed for auctioning any item identified in the database computer by displaying, during a negotiation phase and an auction phase of the present invention, the current price of the item, the quantity of the item remaining available for purchase and the measure of the time remaining in the negotiation and auction phases. The application software provides for indicating instructions to purchase the item at a displayed current price, continually updating the current price of the item, the quantity of the items remaining available for purchase, showing the product indicated as purchased. The application software is also written in a way to indicate the time remaining in the auction in order to provide dynamic feedback to each user and removing the user from the auction after obtaining identification and required financial authorization for the purchase of the item.

Referring back to the negotiation and auction phases of the inventive Internet auction system and method, each seller sets up a designated time when the auction phase will begin. The starting price of the item to be auctioned is also designated. The negotiation phase is established before the beginning of the auction phase to provide potential buyers, i.e. bidders with a chance to compete. For example, the seller places a book for 300 dollars and sets up a designated time and duration of the auction phase. In addition, the seller sets up the time when the negotiation phase will begin. When the negotiation phase begins and in the process of the negotiation phase, the seller monitors the negotiating process between the bidders and based on development of the negotiation process between the bidders and the seller's need to sell the item due to various circumstances, the seller may decrease the price of the negotiated item and/or move the item to the auction phase before the designated time, thereby selling the item as quick as possible encouraging the bidders to compete between one another.

Another function, for example, is designed for coordinating an electronic communication between a potential-buyer and a plurality of potential sellers via the inventive Internet auction system and method with the sellers competing one with the other and simultaneously communicating with the potential buyer via the Internet. The aforementioned software is designed to display, i.e. post a desired item in a web site, and simultaneously receive data, such as the desired item's description, image, if available or if requested, and other information, from the potential sellers. The software allows the buyer to monitor and control competing interaction between various sellers and to coordinates communication between these sellers to make a final choice.

In summary, the inventive system includes a software that allows a buyer to monitor and control competing interaction between various sellers by simultaneously accessing the desired item's description, image, if available or if requested, and other information, and coordinating communication between these sellers to make a final choice. A computer based auction system, wherein any potential seller, placing an item on auction, may monitor a negotiating process between potential bidders during a negotiation phase and based on development of the negotiation between the bidders and the seller's need to sell the item due to various circumstances, the seller may decrease the price of the negotiated item and/or move the item to the auction phase before the designated time, thereby selling the item.

The objective of the project is to create an application on URL http://www.siliconbid.com/. The front-end of the application will be an online auction designed to serve as a tool for buyers and sellers of manufacturing equipment, and the back-end will be an administration panel providing tools for managing all aspects and all activity on the website.

### Table of Contents

### Authentication

In order to buy, sell and use any part or feature of User CP described further in this specification, users need to register an account once and then use the account name and password to authenticate on the site (Login).

### Registration

“Register Now” link always appears on the top left of main menu, as long as user is not logged in. By clicking on that link visitor can start registration process. First, users must agree with Terms and Conditions. If disagreed, return to homepage. If agreed, display registration form for input of the following information (*—required fields):

1. Login*

2. E-mail *

3. Password *

4. Confirm Password *

5. Secret Question * (drop-down list, editable via Master Management page of Admin CP)

6. Answer *

7. First Name *

8. Last Name *

9. Street Address *

10. Address Line 2

11. City *

12. State/Province *

13. Zip/Postal Code *

14. Country*

15. Time Zone * (drop-down list)

16. Phone

17. Work Phone (* at least one phone number must be provided)

18. Fax

19. Company Name

20. Title

21. Industry

22. Website

23. Human Code * (a random 5-character code is generated and displayed as a distorted picture, user must type it into this field. This is to verify that visitor is not a bot program)

Upon submission, a confirmation link should be generated and sent to the email address provided during registration. The link must contain randomly generated verification code, which will be also stored in database and matched when user clicks on the link to confirm his email address and complete the registration process. User is notified by email upon successful registration.

Notes:

Passwords must be protected by encryption.

Following fields must be verified before form submittal:

Email—must be of proper structure—<name>@<domain>.<TLD>. In other words, it must contain “@” symbol, something on the left of @, and something on the right of with at least one “.”

First Name—[a-z, A-Z, space]

Last Name—[a-z, A-Z, space]

Phone: digits and “-” are allowed

Work Phone: digits and “-” are allowed

Fax: digits and “-” are allowed

City: [a-z, A-Z, space]

State/Province: [a-z, A-Z, space]

Zip/Postal Code: [0-9, a-z, A-Z]

Display error message next to the field where mistake is detected.

In order to avoid conflicts, a series of tests must be executed prior to adding a record to the database:

1. Is this email registered with another account?

2. Is username already registered?

3. Does password meet security requirements?

If any of the tests fails, user must review and change registration info (the field that needs to be modified must be highlighted while the rest of the fields must be automatically field in).

Login

Login procedure is used to authorize bidding, selling, and access to all elements of user's control panel, including messaging system, wanted items and subscriptions management pages.

Login form contains fields for input of the following information:

1. Username

2. Password (symbols in this field should be displayed as asterisks “*”)

Provide a link to “Forgot your password?” mechanism. Users cannot retrieve their password, they can only reset it. To reset a forgotten password, users must submit their email address. A link will be generated and sent to the email address provided by user. The link must contain a randomly generated confirmation code which is also stored in database and matched to the value in the requested URL. By clicking on the link user will be prompted to answer the secret question selected during registration. If answered correctly, user may input a new password, which should be encrypted and stored in the database instead of the old one. Users must be notified by email once their password is reset.

User session timeout value is set on System Settings page of Master Management section of Admin CP.

### User CP

User control panel consists of My Sell, My Buy, My Wanted Items, My Messages, My subscriptions and My Profile management pages. Links to all these pages must be display in menu by default, when user is not logged in. If a visitor clicked on i.e. My Buy, he should be displayed login form, and upon successful authentication he will be redirected to his My Buy page. My Profile link is displayed only when user is logged in.

### My Sell

(see mysell_layout.jpg for layout information and menu names, use mysell_design.png as design template)

My Sell is a sales management system providing tools for creating new auction lots (posting items for sale), managing existing items as well as monitoring and analyzing items that are in different stages of their lifecycle:

Auctions—seller's items that are currently in Auction stage

Negotiations—seller's items that are currently in Negotiation stage. In this stage seller can reduce asking price multiple times (see Bidding), and seller can permanently remove the item while it is in this stage (bidders and those who bookmarked the item are notified by email that the item was removed by seller). Provide appropriate mechanisms for this.

Sold—closed auction lots that received bids equal or higher than final asking price and therefore were sold

Also, My Sell menu contains following elements:

Package Offers—offers on multiple items from potential buyers, which need to be taken an action on. Actions include Reject and Accept (see Package Offer).

My Ads—seller's items that are advertised in Sponsored Listings column of the site (see Sponsored Listings).

Besides, My Sell page serves as a reminder. It notifies seller about changes in statuses of his auction lots and alerts him about such things as shipping deadlines as they are coming, about unread/unanswered questions from buyers in seller's Inbox (see Messages) and about feedbacks that seller needs to leave to buyers.

### New Item for Sale

“New Item for Sale” is a button on MySell page of User CP which displays a form for input of the following information about item (*—required fields):

1. Title*

2. Description*

3. Location*

4. Category* (drop-down list)

5. Lot Quantity*

6. Starting Price*

7. Bid Increment*

8. Asking Price

9. Manufacturer

10. Model

11. Serial number

12. Year

13. Hours

14. Volts

15. Amps

16. Hertz

17. Phase

18. Is calibrated? (If yes, when does the calibration expire?)

19. Is manual included?

20. Is equipment ready for demo?

21. Equipment condition*:
Brand New
Working—specify duration of warranty (i.e. 30 days from date received)
As Is

22. Is item taxable? (If yes, what is the tax %?)*

23. Shipping information (will seller ship? will seller ship overseas?)*

24. Is the unit ready for shipping?
On skids?
Wrapped?
Needs dismantling?
Is the facility where the unit is located equipped with a dock?
If yes, is the dock high?

25. Advertise this item (Learn more . . . )

Asking price is optional, but QuickBuy feature will be only available for items for which the asking price was specified. If no asking price is specified (only starting, which is required), then during Negotiation stage seller can manually start a 24-hour Auction by accepting the current highest bid (see Bidding).

Once the information is submitted, seller can upload up to 4 pictures to be attached to the listing.

After that, a listing preview must be displayed and seller must be able to go back and edit the information or upload different pictures and then see the preview again. When seller is satisfied with the listing, he must click Submit button on the preview page to post the item for sale. Email confirmation will be sent to the seller, saying that the item was successfully posted for sale. Item should appear in categories and search results immediately upon submittal.

If “Advertise this item” option was selected, seller will be prompted to pay sponser's fee once the item is submitted for sale (see Sponsored Listings).

### My Buy

(see mybuy_layoutjpg for layout information and menu names, use mybuy_design.png as design template)

My Buy is a page where buyers can monitor the auctions they are bidding on or are interested in, as well as track the purchases made in the past or see items that they were bidding on but didn't win the auction.

My Buy menu consists of the following elements:

Auctions—items that are currently in Auction stage on which buyer has placed a bid earlier (either during Negotiation or during Auction stage)

Negotiations—items that are currently in Negotiation stage on which buyer has placed a bid earlier

Bookmarks—items bookmarked by the buyer

Purchases—items which buyer won in the past, including both paid and unpaid items

Also, following reminders must be displayed on My Buy page:

I need to:
confirm shipping address for X items
pay for Y items
leave feedback for Z items

If X, Y or Z is zero, then appropriate reminder shouldn't be displayed at all. If a reminder is displayed, user must be able to click on it and see a list of items described by the reminder and manage them in accordance with the reminder.

For example, buyer needs to pay for 3 items so the reminder is displayed. Once user clicks on the reminder, a list of 3 unpaid items should be displayed with Pay Now button next to each item.

### My Wanted Items

This page allows users to put their equipment needs on the list which will be processed by Siliconbid every time a new item is posted for sale by someone else. If the criteria specified for Wanted Item matches the information in the new item posted, user who has the item in My Wanted Items is notified about it by a message and by email.

My Wanted Items menu consists of the following elements:

Show All—display both active and inactive wanted items of user

Active—display active wanted items of user

Inactive—display former wanted items of user

Users can change status of any wanted item to Active or Inactive at any time

### My Messages

All messages (questions from buyers and replies from sellers) must be monitored to prevent direct exchange of contact information between buyers and sellers. Therefore, all messages are first added to message queue which is then reviewed by admins, and messages are either approved and forwarded to the addressee's Inbox, or are declined and the sender is notified that his message didn't go through.

Following folders must be created for each user to help manage the messages:
1. Inbox this folder is opened by default as a home page for My Messages. All incoming messages are stored in this folder, new/unread messages are highlighted with bold font. Amount of new/unread messages is displayed in brackets next to “Inbox” (i.e. “Inbox (4)”)
2. Sent—all sent messages
3. Archived—messages older than 3 months and messages moved here manually
4. Trash—deleted messages and messages that were declined by an admin

Users can move messages between all folders, but Sent messages can't go into Inbox, and messages from Inbox can't go into Sent. For example, if a message from Inbox was moved to Trash, it can only be then moved back to Inbox or to Archived folder, but not to Sent folder.

A new message can only be created from Item Display page via “Ask seller a question” link, but users can reply to each other's messages.

### My Subscriptions

The mechanism of filtered subscriptions is used to provide a tool for registered users making it easier to stay updated about new items posted for sale. In order to create a subscription, users must select categories to subscribe to, select subscription periodicity, and specify a subscription filter.

By subscribing to a parent category, user will receive notifications about matching items posted for sale in the selected category and all of its subcategories.

There are two types of subscription periodicity:
1. Rapid—email is sent to the subscriber as soon as an item that matches his filters is posted for sale. One email contains info about one item.
2. Periodic—email containing a summary of all new matching items posted for sale since last subscription email was sent. The time period is set by authorized administrators in Subscriptions management part of Admin CP.

In order to specify a subscription filter, user must select which informative fields of item record to process, specify a keyword/expression, and select how to treat the keyword.

Multiple informative fields can be selected. Options include:
Title (default)
Description
Manufacturer
Model

Keyword/Expression can be treated in the following ways:
Contains (default)—if specified keyword is used in any of the selected informative fields of a new item which was just posted for sale in matching category, subscriber will be notified.
Begins with—beginning of every selected field is checked whether it matches the keyword
Matches—keyword/expression must exactly match one of the selected informative fields
RegEx—specified string is a regular expression which will be matched to every selected field (advanced use)

Users must be able to add/edit/remove subscriptions via subscriptions management page. Users must be logged in to access this feature.

### My Profile

Link to this page is only visible to authenticated users and is located on the right of main menu.

On My Profile page users can edit their personal information, change passwords and email addresses.

All information fields must be displayed, but only the following can be changed:

E-mail

Password

Secret Question

Answer

Street Address

Address Line 2

City

State/Province

Zip/Postal Code

Country

Time Zone

Phone

Work Phone (* at least one phone number must be provided)

Fax

Company Name

Title

Industry

Website

In order to change email on profile, user has to confirm the new address just as he did during registration. When the form is submitted, check if email field has changed. If it did then display the message “A confirmation link was sent to the email address you specified. Click that link to activate new email address in your profile”. Generate confirmation link and send it to new email. Only after user has confirmed his email, it will be changed in his profile. Keep the old one until the new one is confirmed.

In order to change password, user must provide the old password, new password, and confirm new password.

To change secret question user must provide his password, select new question, specify new answer, and confirm the answer.

### Online Store

(see home_layoutjpg for layout information and menu names, use home-design.png as design template)

Online store is mainly presented on the home page. It includes category tree in the frame on the left, search, main frame and sponsored listings column. Main frame is used to list items in selected category, display search results and items.

### Category Tree

Category tree will be presented on the left side of homepage and is managed via Admin CP. Every category can contain as items as subcategories, which in turn can contain items and subcategories as well. Visitors must be able to click on a category to expand it and select or expand a subcategory. Every time a category (subcategory) is clicked, all items in that category (subcategory) are displayed in the main frame as search results (see below).

The amount of items in each category and all of its subcategories is displayed next to each element of category tree in brackets. For example, if there's a category Equipment with 20 items and 3 subcategories (SMT—15 items, Injection Molding—23 items, Metalworking—17 items), then in category tree this will look like this:

Equipment (75)

|—SMT (15)

|—Injection Molding (23)

|—Metalworking (17)

### Search

Simple search form should be present on all pages of website below main menu. It must contain a field for input of the search string and a drop-down list of category tree, which will allow visitors to perform search within specific category. Simple search should process following fields of item record with “Contains” query:

Title

Description

Model

Manufacturer

Year

Next to the simple search form provide a link to Advanced search page, which will allow visitors to search by item number or in specific fields only (i.e. by model number, by brand, etc). Following fields should be present:

1. Item ID

2. Title

3. Manufacturer

4. Model

5. Filter by Price Range

6. Filter by Category

7. Filter by Year

### Search Results

Search results are displayed as a multi page list in the main frame of the site. Items in the list contain title, beginning of description, amount of bids, current highest bid, asking price, status (Negotiation/Auction), Bid and QuickBuy buttons. If item is in Auction stage, also display auction end time adjusted to user's time zone (if logged in), or in seller's local time with his time zone suffix; also display how much time is left till the end of the Auction stage in format “Auction will end in HH hours MM minutes”.

A thumbnail should be displayed for items with pictures. By clicking on any item in search results visitors should be brought to item display page, which should contain “Back to search results” link.

### Sponsored Listings

Sponsored Listings column located on the right of the homepage is used to advertise items for which sellers have paid sponsor's fee (set in Sponsored Listings part of Admin CP). Items to display must be selected randomly, but the same item will not be displayed until all other items were displayed at least once to any amount of visitors.

Since every sponsored listing must contain a thumbnail picture, there's a requirement for all items to be presented in Sponsored Listings to have at least one picture. Information about items in Sponsored Listings column contains:

Title

Starting Price/Current Bid

Number of Bids

Asking Price

By clicking on a Sponsored Listing thumbnail or title, visitors will be redirected to the appropriate Item Display page.

In order to advertise an item in Sponsored Listings, seller must pay sponsor fee for each item to be advertised. There are three ways to do this:
1. Check “Advertise this item” when posting a new item for sale (see New Item For Sale)
2. By clicking “Advertise this item” link which is available to seller on Item Display page when seller is logged in.
3. By selecting multiple items on MySell page and then choose “Advertise” from “With selected do” drop down list.

Upon successful completion of payment for the amount of sponsor's fee, seller is notified by email that “following items will be advertised”. Item is included in Sponsored Listings only after successful payment.

### Item Display Page

(see item_layout.jpg for layout information and menu names, use item_design.png as design template)

Item is displayed in the main frame (see layout). Following information should be displayed (if provided by seller):

1. Title

2. Status
2.1 Stage (negotiation, auction, sold)
2.2 Stage description (“Auction will start once the current bid meets the asking price” for Negotiation stage, “Auction will close in HH hours, MM minutes” for Auction stage, and “Auction closed” for Sold stage.
2.3 μs the asking price met yet?
2.4 Number of bids (“Bid History”—link)

3. Asking price

4. Starting Price/Current Highest Bid

5. Is item taxable? (If yes, what is the tax %?)?

6. Location

7. Description

8. Lot quantity

9. Manufacturer

10. Model

11. Serial number

12. Year

13. Hours

14. Volts

15. Amps

16. Hertz

17. Phase

18. Is calibrated? (If yes, when does the calibration expire?)

19. Is manual included?

20. Is equipment ready for demo?

21. Equipment condition (brand new, working, as is)

22. Is the unit ready for shipping? (On skids? wrapped? needs dismantling? Is the facility where the unit is located equipped with a dock? Is the dock high?)

If pictures are present, thumbnails should be displayed as a column on the left of the frame. By pointing on a thumbnail, visitors should be able to see a larger version of the picture.

Next to Asking price put the QuickBuy button, and next to Starting price/Current bid put the Bid button.

Also provide a link to “Ask seller a question” mechanism, “Bookmark item” and “Inspection Request” link on top right of the frame.

Display shipping information in a separate area. Information may include:
Seller will ship. Request quote for shipping (link to Shipping Quote Request form, where user has to submit a shipping address (country, state, city, zip code (mailing index)), which is then used to compose a regular message to seller with title “Shipping quote request for item #xxxxxx -<Item Title>”). No other information should be included in the message (buyer's name, street address, etc should NOT be present).
Seller will put the item on buyer's truck.
Buyer is responsible for all shipping arrangements.

If current highest bidder visits the Item Display page, he is notified on-screen that he is the highest bidder. If a bidder that was outbid by another bidder visits the page, he is notified on-screen that he was outbid.

At the bottom of the page display a counter showing how many times this item was viewed/visited.

If the item is in Negotiation stage, and authenticated seller visits the Item Display page, he can also reduce asking price for the item.

### Package Deal

Siliconbid provides the opportunity to buyers to save on shipping and better negotiate the prices by giving an offer on multiple items from the same seller. If the offer is accepted by seller, all items included in package will be sold within 24 hours from a single auction lot.

A link to “See my other items” page must be present on Item Display page. By following the link buyers may browse through all items that seller has for sale and select items that are in Negotiation stage, and then make offer for the package. A minimum of 2 items must be selected to make an offer. This is not a bid, this is an offer sent by email which seller should either accept or discard upon reviewing. Seller does this on Package Offers page of My Sell, where all offers from all buyers are listed in chronological order. Information about every offer contains the list of items (titles), offer amount and date and time offer received. Seller has two choices for each offer:

1. Accept Offer
If an offer is accepted, buyer is notified by email and all items that are in the package become a part of a single 24-hour auction lot and cannot be sold separately anymore. Auction starts as soon as the offer is accepted. Items in the package must still appear in categories and search results, but instead of asking price, starting price and amount of bids there should be “This item is a part of a package. Click here to see it.” Package display page must have all items listed with full specs, descriptions and picture thumbnails, a single BID button, Ask Seller a Question and Add Bookmark links. Buyers, who have previously bookmarked the item or placed Negotiation bid(s) on the item, should be notified by email as soon as package offer is accepted that the item is now a part of a package and that the Auction has started and will end on <date>.

Reject Offer
When rejecting an offer, seller has an option to submit Suggested Price for the package. This price will be included in email message sent to buyer who made the offer. Also, a link to “Retry offer with a different price” should be included in that email. This link will bring the buyer to Make Package Offer page with appropriate items selected (as in original offer) and the Offer Amount field containing suggested price if submitted by seller at the time of offer rejection.

Once the item is in a package, it should still count as in its original category (even though the package itself is in Package Deals on top), and when you click on that category the item should appear on the right.

For example I have an item Scope in category Equipment/Inspection/Microscopes. Someone made me an offer for this item and few extra parts for it, which I accepted, and now there's a package named Scope with Accessories, which includes these items. So when somebody clicks on Package Deals on top of category tree, he will see the package on the right. And when somebody clicks on Equipment, or Inspection, or Microscopes in category tree, item Scope should appear on the right with status Part of a Package.

### Bidding

As soon as an item is posted for sale (confirmation email is sent to seller) it appears in categories and search results and is in Negotiation stage. During Negotiation stage buyers can place incremental bids and seller can lower the asking price multiple times. Once reduced, asking price cannot be increased back. Item remains in Negotiation stage until a bid equal to or higher than the current asking price is placed, or until seller reduces the asking price to the amount of current highest bid, or until the item becomes a part of a package (see Package Deal).

The highest bidder must be given an ability to remove his bid during Negotiation stage, but not earlier than in one week after the bid was placed. Every time buyer places a bid, he is notified by email that he is the highest bidder, seller is notified by email that his item received a bid in the amount of . . . , and previous highest bidder is notified that he was outbid. When seller reduces the asking price, all bidders and those who have bookmarked the item are notified by email. If the highest bidder removed his bid, he and seller are notified by email, and the previous highest bidder receives an email saying that a higher bid was removed and that he is the highest bidder now. He, in turn, can remove his bid if he doesn't want to pay that much money for the item anymore, or he can continue bidding on the item. All those who have bookmarked the item are notified if a bid is removed, too.

As soon as the current bid meets the asking price, item is moved to Auction stage.

Duration of Auction stage is 24 hours. During this stage buyers can place incremental bids. Every time buyer places a bid, he is notified by email that he is the highest bidder, and previous highest bidder is notified that he was outbid. Whoever is the highest bidder at the end of the Auction wins the item. If item didn't receive any bids during Auction stage, then whoever placed negotiation bid which met the asking price wins the auction. Buyers cannot remove their bids during Auction stage.

Once the Auction is closed, seller is notified by email that his item was sold, winner is notified that he won the item, all participating bidders are notified that they didn't win the item, and those who had the item bookmarked are notified that the auction for the item is closed.

If the winner didn't participate in bidding during Negotiation stage and started bidding in Auction stage, he is charged a penalty in the amount of 1% of winning bid (see Payments). This is done to stimulate bidding during Negotiation stage.

### Proxy Bid

The concept of proxy bid is used to automate bidding during the Auction stage (only!). When bidding on an item buyer can choose whether to place an actual bid for the amount specified (not less than current bid+increment (set by seller)) or to use the amount specified as buyer's maximum bid and place an actual bid in the amount only necessary to become the highest bidder (current bid+1 increment), and then automatically place such bids (+1 increment) whenever buyer is outbid by somebody else up to the amount of buyer's maximum bid.

For example:
1. Current bid is $1000, bid increment is $100
2. Buyer1 places a maximum bid of $2000
3. System automatically places a bid of$1100 and Buyer1 becomes the highest bidder. He is notified about this on screen and by email
4. Buyer2 places an actual or a maximum bid of $1500
5. Instantly, system places a bid as Buyer1 in the amount of $1600 and Buyer2 is notified by email that he was outbid by another bidder
6. Buyer2 places an actual or a maximum bid of $2000 (which is equal to the maximum bid of Buyer1)
7. System places a bid as Buyer1 in the amount of $2000 and Buyer2 is notified (on screen and by email) that he was outbid by another bidder
8. Buyer2 places a maximum bid of $2500
9. System automatically places a bid of $2100 and Buyer2 becomes the highest bidder. He is notified about this on screen and by email, and Buyer1 is notified by email that he was outbid by another bidder.

### Bid History

On item display page next to the amount of bids (only if amount of bids >0) display a link to Bid History page. Users must login to access this feature. On Bid History page all bids that the item has received are listed in descending order.

### EXAMPLE

Auction's bids

| | | |
|---|---|---|
| YKKgq39 | $61.00 | 02:14 PM, 7th Jan. 2006 |
| YK9pB8 | $58.00 | 02:13 PM, 7th Jan. 2006 |
| YKKgq39 | $57.00 | 02:13 PM, 7th Jan. 2006 |
| YK9pB8 | $56.00 | 02:12 PM, 7th Jan. 2006 |
| YK9pB8 | $55.00 | 02:11 PM, 7th Jan. 2006 |
| YK9pB8 | $54.00 | 02:11 PM, 7th Jan. 2006 |
| YKKgq39 | $53.00 | 02:11 PM, 7th Jan. 2006 |
| YK9pB8 | $52.00 | 02:11 PM, 7th Jan. 2006 |
| YKKgq39 | $51.00 | 01:12 PM, 7th Jan. 2006 |
| YK9pB8 | $50.00 | 01:12 PM, 7th Jan. 2006 |
| YKKgq39 | $44.00 | 09:12 AM, 7th Jan. 2006 |
| YKKgq39 | $42.00 | 08:35 AM, 7th Jan. 2006 |
| YKKgq39 | $42.00 | 08:52 AM, 7th Jan. 2006 |
| YKKgq39 | $36.00 | 08:29 AM, 7th Jan. 2006 |
| YKKgq39 | $34.00 | 08:29 AM, 7th Jan. 2006 |
| YKKgq39 | $29.00 | 08:29 AM, 7th Jan. 2006 |
| YK9pB8 | $26.00 | 08:24 AM, 7th Jan. 2006 |
| YK9pB8 | $25.00 | 08:22 AM, 7th Jan. 2006 |
| YK9pB8 | $24.00 | 08:20 AM, 7th Jan. 2006 |
| YK9pB8 | $23.00 | 08:19 AM, 7th Jan. 2006 |
| YK9pB8 | $22.00 | 07:53 AM, 7th Jan. 2006 |
| YKKgq39 | $21.00 | 07:34 AM, 7th Jan. 2006 |

Negotiation's bids

| | | |
|---|---|---|
| YKKgq39 | $0.49 | 01:08 PM, 7th Jan. 2006 |
| YK9pB8 | $0.48 | 01:08 PM, 7th Jan. 2006 |
| YKKgq39 | $0.47 | 01:07 PM, 7th Jan. 2006 |
| YK9pB8 | $0.46 | 01:07 PM, 7th Jan. 2006 |

### Payment Options (End of Auction)

The highest bidder at the end of Auction stage is considered a winner. If winner didn't participate in bidding during Negotiation stage, he is charged an additional penalty in the amount of 1% of the winning bid (this applies to both payment scenarios described below).

Winner is given two choices:
1. Pay the fee (10% of the winning bid=5% buyer's premium plus 5% seller's fee)+1% penalty (if applicable) and receive seller's contact information for further payment and shipping arrangements. In this case as soon as the fee is paid, seller receives by email an automatically generated purchase order (PO) from winner, who receives a copy of the PO by email. The PO stands that winner agrees to buy the item from seller for the amount of the highest bid minus 5% (since buyer paid seller's fee to Siliconbid Inc.). Seller agrees to sell the item for that amount to the winner and seller will not sell the item to anybody but the winner during the specified period of time.
After the PO is sent to seller and buyer, Siliconbid is not involved any longer.
In this scenario payment options include:
   Credit Card
   Wire Transfer
   PayPal
   Business Check

If the PO terms are violated by winner (winner didn't pay seller for the item), no refunds are made. Simply put, winner loses the money paid in fees to Siliconbid Inc., and previous highest bidder during Auction stage (only!) is given a second chance to win the item. He is offered (by email) to confirm his bid. If the bid is confirmed, then he is considered a winner (he and seller are notified by email) and he is given same two payment options as previous winner (he has to either pay fees and receive seller's info or pay in full (see below)). If the bid is rejected, then whoever placed a bid before him is offered to confirm his bid, etc. If none of the Auction stage bidders confirmed their bid or if there was only one bidder in Auction stage (which didn't pay for the item), then item is moved back to Negotiation stage with the last asking price from which the Auction stage has started.

If the PO terms are violated by seller (seller didn't sell the item to winner), Siliconbid Inc. will send a check by mail to the winner to refund all the money paid (5% buyer's premium+5% seller's fee), leave negative feedback to seller and invoice him for the amount of seller's fee (5% of winning bid). If seller doesn't pay the fee within two weeks, his account is suspended until seller's fee and all late payment charges are paid off by seller.
2. Use Siliconbid to make a full payment, which includes the amount of highest bid, 5% buyer's premium, sales tax and shipping cost (if applicable). First buyer has to choose the next step:

Arrange Shipping Directly With Seller

In this case buyer will be brought to payment page for the amount of

Winning Bid+Tax(if applicable)+5% of Winning Bid(Buyer's Premium)+Transfer Fee(2.5%)
Siliconbid will withhold Seller's Fee (5% of Winning Bid) and Buyer's Premium (5% of Winning Bid), and then forward the rest of the amount (95% of Winning Bid+Tax) to seller's banking account. As soon Siliconbid confirms the payment (via Payments Management page of Admin CP), seller's information is released to the winner (on screen and sent to Inbox), and seller receives by email an automatically generated PO from winner. The PO stands that winner have made a payment in full and that he will contact seller for shipping arrangements. After this, Siliconbid, Inc. is no longer involved.

Let Seller Ship the Item
In this case buyer will need to confirm shipping address via MyBuy page first. When this is done, buyer receives an email notification that he has confirmed shipping address, and seller receives an email containing the shipping address. Seller has to quote the shipping cost for buyer via MySell page. When buyer receives the quote in his Inbox, he can either accept it and proceed with the payment or he can reject the quote and choose to arrange shipping directly with seller (see above). If the quote is accepted, buyer is brought to payment page for the amount of

Winning Bid+Tax (if applicable)+5% of Winning Bid (Buyer's Premium+Shipping+Transfer fee
Siliconbid will withhold Seller's Fee (5% of Winning Bid) and Buyer's Premium (5% of Winning Bid), and then forward the rest of the amount (95% of Winning Bid+Tax+Shipping Cost) to seller's banking account. As soon as the payment is confirmed by Siliconbid, buyer receives a receipt by email and seller receives an automatically generated PO from winner. The PO stands that winner have made a payment in full and that seller is responsible for shipping the item. After this, Siliconbid, Inc. is no longer involved.

In this scenario payment options include:
Credit Card (for payments less than $3000)
Wire Transfer
PayPal
Business Check payable to Siliconbid, Inc.
Cashier's Check payable to Siliconbid, Inc.

### Shipping

Only used when payment is made in full.

When shipping to an address different from the address in buyer's profile, the new shipping address is saved. Next time when buyer wants to use this address for shipping, he can simply select it from the list of previously used shipping addresses. Multiple addresses can be stored.

### Feedbacks

Feedbacks allow users to build reputation. Once a transaction is complete seller and buyer can leave a feedback for each other. A feedback is limited by length so that it takes only one line of screen text. Total amount of feedbacks received by a user must be placed in parentheses next to user's name everywhere on the site (i.e. MasterSurplus (31)). Visitors may read feedbacks about any user and see his feedback score by clicking on his username throughout the website (for example by clicking on seller's or high bidder's username on Item Display page).

There are 3 types of feedbacks that users may leave: positive, negative and neutral. Neutral feedbacks only affect total amount of feedbacks received by the user, while positive and negative feedbacks affect both total amount of feedbacks received by the user and his feedback score. Feedback score is presented in percents and is calculated by the following formula:

$$Feedback Score = \frac{Positive Feedbacks}{Positive Feedbacks + Negative Feedbacks} * 100 \%$$

Users cannot edit or remove feedbacks left for others nor received from others.

### Inspection Request

On Item Display page provide a link to Inspection Request form for items that are in Negotiation stage.

Inspection is a paid service provided by Siliconbid to potential buyers who are willing to verify that:
1. Item on the auction lot is an actual existing item
2. Condition of the item is as described in the listing
3. Tag information is correct (model number, serial number, power, etc.)

In order to request an inspection buyer must complete the Inspection Request form:

1. Item ID

2. Title

3. Username

4. First Name

5. Last Name

6. Email

7. Contact Phone

8. Notes

Most of the fields will be filled in automatically using the information from user's profile. However, user can change information in fields 6-8 on the form before submittal. Fields 1-5 cannot be modified.

Siliconbid, Inc. will review the request and quote the inspection. Message containing the quote will be sent to user's Inbox and he will be notified by email. If user accepts the quote by clicking on the link included in the message, he must be brought to the payment page for the amount specified in the quotation. Once the inspection fee is paid, user is notified by email that Siliconbid, Inc. will perform the inspection within a specified period of time and then user will be contacted to present the results no later than . . .

### Admin CP

Admin control panel provides tools for administrators for managing all aspects and activity on the website. It consists of multiple parts, access to which is controlled by superuser, who in turn has access to all parts of the Admin CP. Only superuser can create/edit/delete administrative accounts and grant access for every account to the specific areas of Admin CP. User accounts and administrative accounts are not related and must be stored in separate tables of the database. Superuser can also monitor activity of administrators, so every action performed by an admin must be logged and superuser or an admin that was granted this privilege should be able to read these logs via Admin CP.

### Items

This part of Admin CP allows administrators to edit/delete items posted on the website. They must be able to modify all informative fields of an item, change item status and terms of sale, set auction time and deadlines to specific value. Only modified fields should be updated in database, so that auction time doesn't change if i.e. only item description was modified. Admins must be able to select multiple items from the list and perform an action on them (i.e. “With selected do: Delete|Move to Auction|Move to Negotiation|Move to another category”).

### Wanted Items

On this page admins can see all items that are in My Wanted Items lists of all users, filter them by brand, model, category and by user. Information displayed must include title, description price/budget (if specified), date posted, user who posted, status (Active/Closed). Any informative field of any item can be edited by an authorized admin, any item can be deleted. Admins must be able to select an item and compose a message to user who posted it with the subject “Re: My Wanted Item -<item title>”.

### Users

In this section of Admin CP administrators can:
1. Modify existing user accounts (change user details, reset passwords, etc.)
2. Permanently delete accounts
3. Suspend accounts (either indefinitely or for a certain period of time) and restore them. Admins should be given an option whether to notify user by email upon suspension or not Send emails to users directly from Admin CP.
4. Admins must be able to select multiple users from the list and perform an action on them (i.e. “With selected do: Delete|Suspend|Restore|Email”).

### Categories

This is where the category tree can be modified. To create a new (sub)category, admins must select a parent category and specify the name for a new category. Categories can be renamed; subcategories can be moved to another category. When moving a category, admin must choose what to do with items and subcategories in it. They can be moved together with the category, moved to the parent category of the category that's being moved, or they can be moved to another category of administrator's choice.

When deleting a category, admin must choose what to do with items and subcategories in it as well. They can be deleted, moved to the parent category or moved to another category of administrator's choice.

### Messages

This part of Admin CP provides tools for managing message queue as well as messages stored in users' Inbox, Sent and Archived folders. Message queue must be presented as a list of messages with full messages displayed and Approve, Decline and Edit buttons placed next to each message. Admins must be able to select multiple messages from queue and perform an action on them (i.e. “With selected do: Approve|Decline”). When a message is approved, it is forwarded to addressee's Inbox folder where it is highlighted as new/unread and he is notified by email that he has a new message in his Inbox. When a message is declined, it is moved to sender's Trash folder and he is notified by email that his message was declined. In order to manage messages in user's folders, admins must first select a user from a list or search for a user by details and then select one. Then messages may be edited, deleted or moved between folders. A message cannot be moved from one user to another.

### Feedbacks

Here administrators can edit or delete users' feedbacks. In order to do this admin must first select a user from a list or perform a search for a user by details. Only feedback type (positive, negative, neutral) and text can be modified. Admins must be able to select multiple feedbacks from the list of user's feedbacks and then perform an action on them (i.e. “With selected do: Delete|Set type to positive|Set type to negative|Set type to neutral”).

### Subscriptions

This part allows administrators to manage subscriptions. Admins should be able to search subscriptions by type (rapid/periodic), by subscription ID, by user ID, by email, by filter, by date (older than . . . , newer than . . . ) and by category. Then subscription filters can be changed or subscription can be canceled or restored. Admins must be able to select multiple subscriptions from the list and then perform an action on them (i.e. “With selected do: Cancel|Restore”). When a subscription is cancelled, user is notified by email. Subscription service can be stopped or started at any time. Admin must select whether to notify all subscribers by email that the service was stopped/started, or simply perform the action with no notifications sent.

Also, admins should be able to set the time period for periodic subscriptions.

### Sponsored Listings

In this section admins can see which members have paid sponsor's fees for which items, how many items each user has in sponsored listings, how many times has the listing been displayed. Also, admins may suspend/restore selected sponsored listings (with or w/o an email notification of seller) or remove them permanently (the listing itself stays though, it is simply excluded from sponsored listings).

The amount of sponsor's fee is also set here.

### Inspections

Basically, this is a message center configured to receive and quote inspection requests from users (see Inspection Request). Admins must be able to read incoming requests (new/not quoted requests highlighted) and reply to them with quotation, as well as see inspection history with complete inspection details:

Item ID

Title

Location

Requestor (link to user profile)

Seller (link to user profile)

Request Date

Quotation Date and Amount

Payment Date, Amount and Reference Number

Date Completed

Inspection Results

### Email Templates

Here administrators can edit HTML templates for each email notification sent by siliconbid.com to its users. Every template has its own set of variables which can be used in HTML and will be replaced by actual values when sending an email using the template. For example, if buyer is asking seller a question about item with title “Fuji Feeders”, then “@@ItemTitle@@” in template will be replaced by “Fuji Feeders” in email. A complete list of email templates and sets of variables for them is below:

Following 8 variables are available globally in all templates:
1. Current Date
2. Current Time
3. Home URL
4. Contact info (this is a static text stored in a separate template (Text and HTML versions))
5. Link to User Agreement
6. Link to Terms And Conditions
7. Link to Privacy Policy
8. Link to Fee Policy

NOTE* All User IDs must be anchored with a link to appropriate User Info page, which contains information about seller (feedback scores, feedbacks, etc)

Email Verification Link (to User During Registration):
1. User ID
2. User Full Name (first name and last name)
3. User Email
4. Confirmation link
5. Link to Registration page of Help System

Registration Successful
1. User ID
2. User Full name
3. User Email
4. Link to Login page
5. Link to Login page of Help System

Reset Password Link
1. User ID
2. User Full Name
3. User Email
4. Reset Password link
5. Link to Password Reset page of Help System

Password Successfully Reset
1. User ID
2. User Full Name
3. User Email
4. Link to Login page
5. Link to Login page of Help System

Item Removed by Seller (To Bidders)
1. Bidder ID
2. Bidder Full Name
3. Bidder Email
4. Item ID
5. Item Title
6. Date/Time Item Removed
7. Seller ID

Item Removed by Seller (to Those Who Bookmarked the Item)
1. Buyer User ID (who bookmarked)
2. Buyer Full Name
3. Buyer Email
4. Item ID
5. Item Title
6. Date/Time Item Removed
7. Seller ID

You Removed Your Item (To Seller)
1. Seller ID
2. Seller Full Name
3. Item ID
4. Item Title
5. Date/Time Item Posted
6. Date/Time Item Removed
7. Starting Price
8. Asking Price
9. Bid Increment
10. Number of bids when item removed
11. Current high bid amount when item removed

Item Posted for Sale (To Seller)
1. Seller ID
2. Seller Full Name
3. Item ID
4. Item Title
5. Item URL
6. Starting Price
7. Asking Price
8. Bid Increment
9. Link to MySell page of Help System

Item Matching Your Wanted Item was Posted for Sale (to User)
1. User ID
2. User Full Name
3. Item ID
4. Item Title
5. Item URL
6. Starting Price
7. Asking Price
8. Link to Wanted Items page of Help System

Message Declined (To Sender)
1. Sender ID
2. Sender Full Name
3. Addressee User ID
4. Date/Time message sent
5. Message Title
6. Message Body
7. Denial Reason
8. Message URL (in sender's Trash folder)
9. Link to Message Declined page of Help System

New Message in Your Inbox (to User)
1. User ID
2. User Full Name
3. Sender ID
4. Message Title
5. Message URL
6. Link to My Messages page of Help System

Following Items Will be Advertised (To Seller)
1. Seller ID
2. Seller Full Name
3. Items Array (contains a list of IDs and Titles of items to be advertised; Titles should be anchored with links to appropriate Item URLs)
4. Advertising period
5. Advertising end date
6. Link to Advertise Items page of Help System

Item Bookmarked (to User)
1. User ID
2. User Full Name
3. Item ID
4. Item Title
5. Item URL
6. Link to Bookmarks page of Help System

Shipping Quote Request (To Seller)
1. Seller ID
2. Seller Full Name
3. Item ID
4. Item Title
5. Item URL
6. Buyer ID
7. Shipping Destination (Country, State and City ONLY! No other information included)
8. Reply/Contact Buyer link (brings to Compose New Message page of the site)
9. Link to Shipping Quote Request page of Help System

Package Offer (To Seller)
1. Seller ID
2. Seller Full Name
3. Buyer ID
4. Items Array (contains a list of IDs and Titles of items in the package; Titles should be anchored with links to appropriate Item URLs)
5. Offer Amount
6. Offer URL (brings to the package display page where all items in package are listed with thumbnails on a single page, which also contains Accept and Reject buttons (consult with spec))
7. Link to Package Offer page of Help System

Package Offer Rejected (To Buyer)
1. Buyer ID
2. Buyer Full Name
3. Seller ID
4. Items Array (contains a list of IDs and Titles of items in the package; Titles should be anchored with links to appropriate Item URLs)
5. Offer Amount
6. Offer URL
7. Rejection Reason
8. Link to Package Offer page of Help System

Package Offer Accepted (To Buyer)
1. Buyer ID
2. Buyer Full Name
3. Seller ID
4. Items Array (contains a list of IDs and Titles of items in package; Titles should be anchored with links to appropriate Item URLs)
5. Offer Amount
6. Bid Increment
7. Auction End Time
8. Auction URL (for offer)
9. Link to Package Offer page of Help System

Item You Bookmarked Became a Part of a Package
1. User ID
2. User Full Name
3. Seller ID
4. Item ID
5. Item Title
6. Item URL
7. Package URL
8. Link to Package Offer page of Help System

Item You are Bidding on Became a Part of a Package
1. User ID
2. User Full Name
3. Seller ID
4. Item ID
5. Item Title
6. Item URL
7. Package URL
8. Link to Package Offer page of Help System

Item Received a Negotiation Bid (To Seller)
1. Seller ID
2. Seller Full Name
3. Item ID
4. Item Title
5. Item URL
6. Bidder User ID
7. Bid Amount
8. Link to Negotiation page of Help System

Item You Bookmarked was Moved to Auction
1. User ID
2. User Full Name
3. Seller ID
4. Item ID
5. Item Title
6. Item URL
7. Auction Starting Bid (asking price)
8. Number of Negotiation bids
9. Auction End Time
10. Link to Auction page of Help System

Item Moved to Auction (To Bidders)
1. Bidder ID
2. Bidder Full Name
3. Seller ID
4. Item ID
5. Item Title
6. Item URL
7. Auction Starting Bid (asking price)
8. Number of Negotiation bids
9. Auction End Time
10. Link to Auction page of Help System

Asking Price Reduced for Bookmarked Item
1. User ID
2. User Full Name
3. Seller ID
4. Item ID
5. Item Title
6. Item URL
7. Asking Price
8. Number of bids
9. Current High bid

Asking Price Reduced (To Bidders)
1. Bidder ID
2. Bidder Full Name
3. Seller ID
4. Item ID
5. Item Title
6. Item URL
7. Asking Price
8. Number of bids
9. Current High bid
You were Outbid
1. User ID
2. User Full Name
3. Seller ID
4. Item ID
5. Item Title
6. Item URL

You Placed a Bid in the Amount of <Bid Amount> and You are the Highest Bidder
1. User ID
2. User Full Name
3. Seller ID
4. Item ID
5. Item Title
6. Item URL
7. Number of Bids
8. Bid amount (Current high bid)

You Placed a Maximum Bid of <Max Bid Amount> and an Actual Bid of <Bid Amount>, You are the Highest Bidder Now (to Proxy Bidder)
1. User ID
2. User Full Name
3. Seller ID
4. Item ID
5. Item Title
6. Item URL
7. Number of Bids
8. Bid amount (user's maximum bid)
9. Actual bid placed by the system (Current high bid)
10. Auction End Time

You Removed Your Bid
1. User ID
2. User Full Name
3. Seller ID
4. Item ID
5. Item Title
6. Item URL
7. Bid Amount (retracted bid)
8. Current High Bid
9. Asking Price
10. Number of Bids

A Bid was Removed (To Seller)
1. Seller ID
2. Seller Full Name
3. Item ID
4. Item Title
5. Item URL
6. Bidder ID (who retracted the bid)
7. Bid Amount (retracted bid)
8. Current High Bid
9. Number of Bids
10. Asking Price
11. Current High Bidder ID (if any)

a Higher Bid was Removed; You are the Highest Bidder Now (to Previous Highest Bidder)
1. User ID
2. User Full Name
3. Seller ID
4. Item ID
5. Item Title
6. Item URL
7. Current High Bid (User's bid)
8. Number of Bids
9. Asking Price

You Won the Item
1. User ID
2. User Full Name
3. Seller ID
4. Item ID
5. Item Title
6. Item URL
7. Winning Bid
8. Number of Bids

You Didn't Win the Item (To Bidders)
1. User ID
2. User Full Name
3. Seller ID
4. Item ID
5. Item Title
6. Item URL
7. Number of Bids
8. Winning Bid Amount

Auction Closed for Item You Bookmarked
1. User ID
2. User Full Name
3. Seller ID
4. Item ID
5. Item Title
6. Item URL
7. Number of Bids
8. Winning Bid Amount

Item Sold (To Seller)
1. Seller ID
2. Seller Full Name
3. Winner ID
4. Item ID
5. Item Title
6. Item URL
7. Winning Bid
8. Number of Bids

Purchase Order (To Seller, Includes Winner's Information)
1. Seller ID
2. Seller Full Name
3. Seller Address
4. Seller Company Name (if any)
5. Seller Phone
6. Seller Fax
7. Seller Email
8. Buyer ID
9. Buyer Full Name
10. Buyer Address
11. Buyer Company Name (if any)
12. Buyer Phone
13. Buyer Fax
14. Buyer Email
15. Winning Bid
16. Seller Fee paid by Buyer (5% of winning bid)
17. Buyer Fee paid by Buyer (5% of winning bid . . . Even though seller's and buyer's fees are 5% and Buyer pays them both, create two separate variables for them, as we may need to change these amounts in the future)
18. Tax amount
19. Total Fees paid by Buyer
20. Amount to be paid by Buyer directly to Seller (95% of winning bid, since buyer paid seller's fees to Siliconbid, Inc.)
21. Item ID
22. Item Title
23. Item URL
24. Item Description (this includes not only Description field, but ALL informative fields of Item record, such as Manufacturer, Model, Serial Number, Year, Hours, etc)

Payment Receipt and a Copy of PO (to Winner, Includes Seller's Information)
1. Seller ID
2. Seller Full Name
3. Seller Address
4. Seller Company Name (if any)
5. Seller Phone
6. Seller Fax
7. Seller Email
8. Buyer ID
9. Buyer Full Name
10. Buyer Address
11. Buyer Company Name (if any)
12. Buyer Phone
13. Buyer Fax
14. Buyer Email
15. Winning Bid
16. Seller Fee paid by Buyer (5% of winning bid)
17. Buyer Fee paid by Buyer (5% of winning bid . . . Even though seller's and buyer's fees are 5% and Buyer pays them both, create two separate variables for them, as we may need to change these amounts in the future)
18. Tax amount
19. Total Fees paid by Buyer
20. Amount to be paid by Buyer directly to Seller (95% of winning bid, since buyer paid seller's fees to Siliconbid, Inc.)
21. Item ID
22. Item Title
23. Item URL
24. Item Description (this includes not only Description field, but ALL informative fields of Item record, such as Manufacturer, Model, Serial Number, Year, Hours, etc)

Second Chance Offer. Confirm Your Bid (to Previous Highest Bidder)
1. User ID
2. User Full Name
3. Seller ID
4. Item ID
5. Item Title
6. Item URL
7. Bid Amount (bid to confirm)
8. Link to Confirm Bid page
9. Link to Second Chance Offer of the Help system

You Confirmed You Bid. You Won the Item!
1. User ID
2. User Full Name
3. Seller ID

Item ID
4. Item Title
5. Item URL

Winning Bid
6. Number of Bids

Second Chance Offer Accepted (To Seller)
1. Seller ID
2. Seller Full Name
3. Buyer ID
4. Item ID
5. Item Title
6. Item URL

Winning Bid (Confirmed 2^{Nd} Chance Bid)
7. Number of Bids

Item Moved Back to Negotiation Stage (To Seller, when Winner Didn't Pay for the Item and None of Auction Stage Bidders Confirmed their Bids)
1. Seller ID Seller Full Name
2. Item ID
3. Item Title
4. Item URL
5. Current High Bid (equal to the bid from which Auction stage has started)
6. Asking Price
7. Number of Bids

Item You Bookmarked was Moved Back to Negotiation Stage
1. User ID
2. User Full Name
3. Seller ID
4. Item ID
5. Item Title
6. Item URL
7. Current High Bid
8. Asking Price
9. Number of Bids

Refund was Mailed (to Winner)
1. User ID
2. User Full Name
3. User Address
4. Seller ID
5. Item ID
6. Item Title
7. Item URL
8. Winning Bid
9. Number of Bids
10. Auction End Date and Time
11. Refunded Amount for Seller's Fee
12. Refunded Amount for Buyer's Fee
13. Total Refund Amount

You Confirmed Shipping Address (to Winner)
1. User ID
2. User Full Name
3. Confirmed Shipping Address
4. Seller ID
5. Item ID
6. Item Title
7. Item URL
8. Winning Bid

Buyer Confirmed Shipping Address (To Seller)
1. Seller ID
2. Seller Full Name
3. Buyer ID
4. Item ID
5. Item Title
6. Item URL
7. Item Location
8. Shipping Destination (this is Country, State, City and/or ZIP Code ONLY!. No street address included!)
9. Link to Quote Shipping Cost page (compose new message to winner)

Shipping Quote is in Your Inbox (to Winner)
1. User ID
2. User Full Name
3. Seller ID
4. Item ID
5. Item Title
6. Item URL
7. Item Location
8. Shipping Address
9. Shipping Cost
10. Link to the message in User's Inbox where he can Accept or Reject the quote

Inspection Request (To Siliconbid Inc.)
1. User ID
2. User Full Name
3. User Phone
4. User Email
5. Item ID
6. Item Title
7. Item URL
8. Item Location
9. Item Description (this includes not only Description field, but ALL informative fields of Item record, such as Manufacturer, Model, Serial Number, Year, Hours, etc)
10. Seller ID
11. Seller Full Name
12. Seller Phone
13. Seller Email
14. Notes (part of Inspection Request form)
15. Link to Inspections page of the Help system

Inspection Quote is in Your Inbox (To Buyer)
1. User ID
2. User Full Name
3. Seller ID
4. Item ID
5. Item Title
6. Item URL
7. Item Location
8. Item Description (this includes not only Description field, but ALL informative fields of Item record, such as Manufacturer, Model, Serial Number, Year, Hours, etc)
9. Estimated Inspection Cost
10. Link to the Inspection Quote message in User's Inbox, where he can Accept the quote and pay for it to initiate the inspection, or he can reject the quote.
11. Link to Inspections page of the Help system

Inspection Fee Paid (To Buyer)
1. User ID
2. User Full Name
3. Seller ID
4. Item ID
5. Item Title
6. Item URL
7. Item Location
8. Item Description (this includes not only Description field, but ALL informative fields of Item record, such as Manufacturer, Model, Serial Number, Year, Hours, etc)
9. Amount of Inspection Fee paid
10. Estimated Date of Inspection completion
11. Link to Inspections page of the Help system

Inspection Results (To Buyer)
1. User ID
2. User Full Name
3. Seller ID
4. Item ID Item Title
5. Item URL
6. Item Location
7. Item Description (this includes not only Description field, but ALL informative fields of Item record, such as Manufacturer, Model, Serial Number, Year, Hours, etc)
8. Date of Inspection
9. Inspection Results (this is the actual message body)

Rapid Subscriptions
1. User ID
2. User Full Name
3. Subscription ID
4. Matching Filter
5. Seller ID
6. Item ID
7. Item Title
8. Item URL
9. Starting Price
10. Asking Price
11. Link to Rapid Subscriptions page of Help System

Periodic Subscription
1. User ID
2. User Full Name
3. Subscription ID
4. Matching Filters and Items Array (this contains filters that matched items posted for sale during the last subscription period, and Item IDs, Item Titles, Item URLs, Seller IDs, Starting and Asking Prices of all items that matched those filters)
5. Link to Periodic Subscriptions page of Help System

Your Account was Suspended (to User)
1. User ID
2. User Full Name
3. User Email
4. Reason of Suspension
5. Suspension Period (if any)

Your Account was Restored (to User)
1. User ID
2. User Full Name
3. User Email
4. Link to Login page

Subscription Cancelled
1. User ID
2. User Full Name
3. User Email
4. Subscription ID
5. Subscription Filter
6. Reason why subscription cancelled

Subscription Service Stopped
1. User ID
2. User Full Name
3. User Email
4. Reason why Subscription service was stopped

Subscription Service Started
1. User ID
2. User Full Name
3. User Email

Sponsored Listing Added
1. User ID
2. User Full Name
3. Item ID
4. Item Title
5. Item URL
6. Advertising period

Sponsored Listing Suspended (To Seller)
1. Seller ID
2. Seller Full Name
3. Item ID
4. Item Title
5. Item URL
6. Reason why advertising was suspended

Sponsored Listing Restored (To Seller)
1. Seller ID
2. Seller Full Name
3. Item ID
4. *Item Title
5. Item URL
6. Comments/Notes (by admin that restored the advertising)

Sponsored Listing Removed (To Seller)
1. Seller ID
2. Seller Full Name
3. Item ID
4. Item Title
5. Item URL
6. Reason why advertising was removed

### Pages

Here authorized administrators can edit informative HTML pages of the website, which include:
About Us
Contact Us
User Agreement
Privacy Policy
Fee Policy
Terms And Conditions

### Help

On this page admins can manage the help system of the website. Provide tools for creation and editing of help sections hierarchy (table of contents) as well as HTML content of all help pages. Help system is more like an informational portal within Siliconbid site with its own search system.

### Banking and Payments

In this part of Admin CP authorized admins can edit Siliconbid Inc.'s banking info, set percentages for all fees and charges, set payment deadlines, as well as monitor payments made through Siliconbid.com. Admins must be able to see detailed payment information for each transaction, which should include buyer's personal info, buyer's account info, transaction ID, transaction status, etc. Also, a refund mechanism should be provided for each transaction (admin must specify the amount to refund). This is done for tracking purposes only. The actual refund will be made by a check from Siliconbid Inc. payable to buyer. When refund is made in the system, buyer is notified by email that he will receive the check by mail.

### Statistics

Provide following statistical reports:

Items:

How many items are in which stage?

How many new items posted per specified period of time?

How many new items received bids per specified period of time?

How many new items were sold per specified period of time?

Users:

How many users registered per specified period of time?

How many visitors are currently on the site?

How many users are currently logged in?

Subscriptions:

How many users have created subscriptions?

How many subscription emails sent per specified period of time?

How many users subscribed to which category?

Financial:

How much fees received per specified period of time?

How much money was paid by credit card through siliconbid.com?

### Admin Logs

In this part of Admin CP superuser and admins that were granted this privilege can monitor the activity of other admins, and see which action was performed by which admin, what was changed and when was the action performed. For example, “Accountant confirmed payment from Seller for item 1234 in the amount of $1234 on Feb. 12, 2007 at 3:46 pm”

1. An auction system for auctioning products on-line comprising;
a plurality of terminals interconnected with one another, and
a software in each of said terminals adopted to allow a buyer to monitor and control competing interaction between various sellers by simultaneously accessing the desired item's description, image, and coordinating communication between the sellers to make a final choice, wherein any potential seller, placing an item on auction, may monitor a negotiating process between potential bidders during a negotiation phase and based on development of the negotiation between the bidders and the seller's need to sell the item due to various circumstances, the seller may decrease the price of the negotiated item and/or move the item to the auction phase before the designated time, thereby selling the item.
